(19) United States
(12) Patent Application Publication
(10) Pub. No.: US 2023/0294028 A1
(43) Pub. Date: Sep. 21, 2023

(54) Apparatus and Method for Enhanced Filtration Utilizing Electric Fields and Filter Media with Conductive Polymeric Coatings

(71) Applicant: Don Hess, Dunedin, FL (US)

(72) Inventor: Don Hess, Dunedin, FL (US)

(21) Appl. No.: 17/699,391

(22) Filed: Mar. 21, 2022

(51) Int. Cl. B01D 46/00; B03C 3/155

(52) U.S. Cl. CPC B01D 46/0032; B03C 3/155; B01D 2239/0435

(57) ABSTRACT

Disclosed is an apparatus and method for enhanced filtration. The apparatus utilizes a series of oppositely charged and opposing grids to condition incoming particles, promote conglomeration, and increase filtration efficiency. A filter media is positioned between two of the opposing grids. The grids opposing the media create an electrical field that polarizes the filter media and further increases filtration efficiencies. Still yet additional filtration efficiencies are realized by coating the filter media with a conductive polymer. The conductive polymer increases the associated dielectric constant to yield additional filtration efficiencies.

### TECHNICAL FIELD

This disclosure relates to an apparatus and method for enhanced filtration. More particularly, the disclosure relates to a filtration apparatus with means for promoting enhanced particle filtration via electric fields and polymeric coated filter media.

### BACKGROUND OF THE INVENTION

All materials are composed of atoms with positively charged nuclei and negatively charged electron clouds. Although the molecules of dielectrics are macroscopically neutral, when placed in an external electric field, a force is exerted on each charged particle which results in a small displacement of the positive and negative charges in opposite directions. These displacements, although small in comparison to atomic dimensions, polarize the dielectric material and creates electric dipoles. The more the molecule displaces, the greater the dipole moment and the stronger the polarization. The present invention uses electrical fields to polarize filter media and thereby enhance filtration.

Increasing indoor air quality has become critically important in recent years. This is especially true in hospitals and clean rooms. But it is equally important to eliminate or reduce allergens, bacteria, and even viruses from residences and workplaces. Airborne contaminants can be either aerosols or gases. Aerosols are composed of either solid or liquid particles. Both types of contaminants exist at the micron and submicron level.

Most dust particles, for example, are between 5-10 microns in size (a micron is approximately 1/25,400th of an inch). Other airborne contaminants can be much smaller. Cigarette smoke consists of gases and particles up to 4 microns in size. Bacteria and viruses are another example of airborne contaminants. Bacteria commonly range anywhere between 0.3 to 2 microns in size. Viruses can be as small as 0.05 microns in size. These small, submicron particles can be very difficult or impossible to filter using conventional filtration techniques.

What is needed, therefore, is a filtration apparatus with increased efficiencies and that is more effective at eliminating submicron sized particles. The filtration apparatus of the present disclosure is designed to fulfill these, and other shortcomings present with existing filtration systems.

### SUMMARY OF THE INVENTION

It is therefore an object of the present disclosure to provide an apparatus with increased filtration efficiencies and that can effectively remove submicron sized contaminants.

Another object of the present disclosure is to expose filtration media to opposing electrical fields to thereby polarize the media and increase its capacity to capture contaminants.

A further object of the present disclosure is to increase filtration efficiencies by coating a filter media with a conductive polymeric material.

Another object of this disclosure is to increase ionization and polarization of the entire filter system.

Another object is to increase polarization of the filter media by applying a doped polymeric material to the filter media.

Another objective of this disclosure is to increase polarization by controlling geometry and placement of charge producing electrodes.

Another objective of this disclosure is to enhance polarization of a filter media via opposing grids that include a minimal physical separation, with the separation increasing the electromagnetic field and greatly enhancing the polarization in the filter media.

Still yet another object of this disclosure is to increase pathogen deactivation by enhancing particle capture via increased ionization and polarization, which traps the pathogens in an electric field to stress and inactivate the pathogens.

Various embodiments of the invention may have none, some, or all these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a diagram of the filtration apparatus of the present disclosure, including a voltage source, three grids, and filtration media.

FIG. 2 is a flow chart illustrating the steps associated with the method of the present disclosure.

FIG. 3 is a graph plotting current emissions versus voltage and illustrating that charge emissions increase as wire diameters decrease.

FIG. 4 is a diagram illustrating how polarization creates dipoles in a filer media.

FIGS. 5a-5c illustrate differing chemical structures for different polymeric materials.

FIG. 6a-6d are diagrams illustrating the differing energy band gaps of different materials.

FIG. 7a-7b are diagrams illustrating how using a doped polymer on a filter media increases the dielectric constant and increases filter efficiency.

Similar reference numerals refer to similar parts throughout the several views of the drawings.

### DETAILED DESCRIPTION OF THE DRAWINGS

The present disclosure relates to an apparatus and method for enhanced filtration. The apparatus utilizes a series of oppositely charged grids to condition incoming particles, promote conglomeration, and increase filtration efficiency. A filter media is positioned between two of the opposing grids, Grid 2 and 3. The grids opposing the filter media create an electrical field that polarizes the filter media and further increases filtration efficiencies. Still yet additional filtration efficiencies are realized by coating the filter media with a conductive polymer. The conductive polymer increases the associated dielectric constant to yield additional filtration efficiencies.

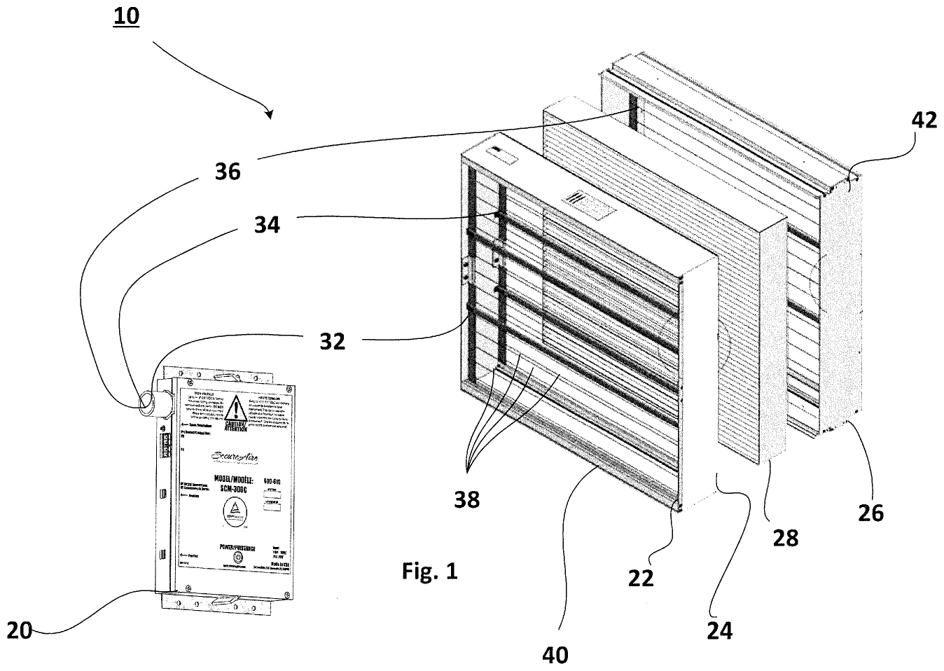

A preferred embodiment of the present apparatus is illustrated in FIG. 1. As illustrated, a voltage is applied to apparatus 10 via power source 20. Power source 20 is a specially designed high voltage generator. Power source 20 includes electrical lines coupling it to the conditioning grids of apparatus 10. In the depicted embodiment, apparatus 10 includes three conditioning grids (22, 24, and 26). However, the invention is not limited to the use of any specific number of grids. Apparatus 10 can, for example, employ four, six, or eight grids. Each conditioning grid includes a series of thin, parallel, and spaced wires 38. Upon the application of a voltage, the wires generate an associated electrical field. In this manner, each grid (22, 24, and 26) carries an associated high voltage electrical field. Although wires 38 are disclosed as being preferred for generating the electrical field, it is within the scope of the present invention to generate the associated electrical field via conductors having other shapes and geometries, such as serrated plates or coiled wires.

In the depicted embodiment, a filter media 28 is positioned between the second and third (24 and 26) conditioning grids. Electrical lines (32, 34, and 36) connect power source 20 to the three respective grids (22, 24, and 26). More specifically, line 32 delivers a negative voltage to the first grid 22, line 34 delivers a positive voltage to second grid 24, and line 36 delivers a negative voltage to third grid 26. As a result, the electrical fields generated by grids 22, 24, and 26 are opposite of one another. These oppositely charged fields could likewise be generated by applying a positive charge to grids 22 and 26 and a negative charge to grid 24. In the depicted embodiment, grids 22 and 24 are positioned within the same housing 40 and grid 26 is positioned within a physically separate housing 42. However, the disclosed arrangement of grids 22, 24, and 26 within housings 40 and 42 is only one of several possible arrangements.

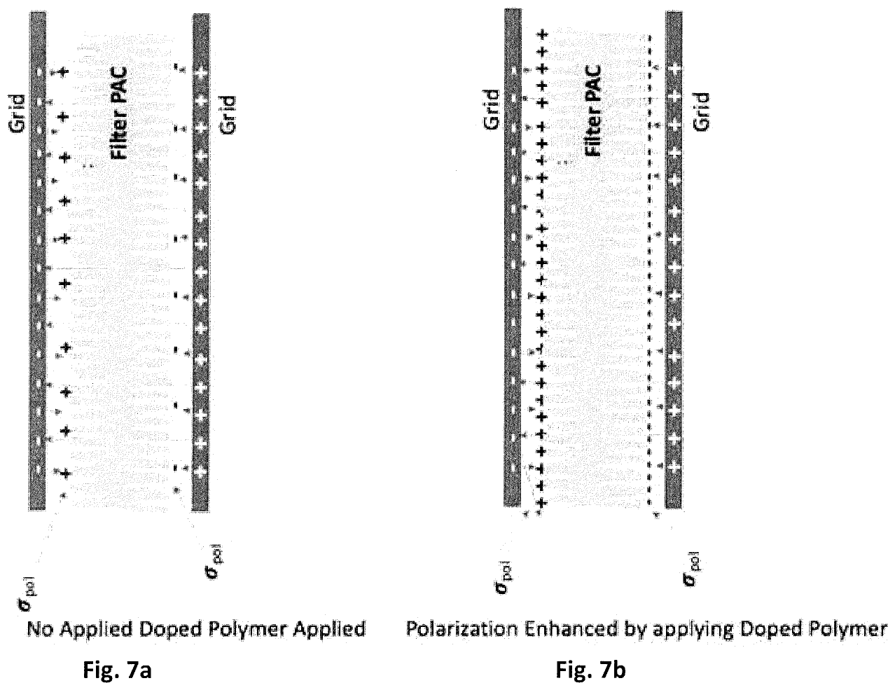

Apparatus 10 is thus configured to condition incoming airborne particles vis the first grid 22. The negative voltage applied to grid 22 ionizes the surrounding particles. By applying an opposite charge to second grid 24, the conditioned particles are attracted to the filter media via second grid 24. This assists in forcing conditioned particles through housing 40 and towards filter media 28. In an important aspect of the disclosure, the opposing second and third grids 24 and 26 create a field between the two grids that polarize the filter media 28. This polarization can be strengthened by decreasing the air gap between grid 24 and the front of filter media 28 as well as the air gap between grid 26 and the back of filter media 28. This polarization increases filtration efficiencies. As described in more detail below, further filtration efficiencies are realized by coating filter media 28 with a conductive polymer. The coating of the filter media with a conductive polymer is illustrated in FIG. 7b.

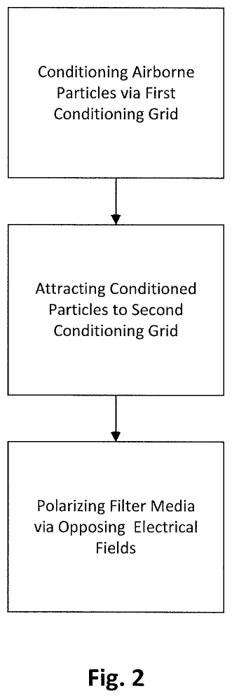

In sum, apparatus 10 allows for increased filtration efficiencies by optimizing the associated electric fields and by resonating the fields to the filtration media. Still yet other efficiencies are realized by applying a doped polymeric coating to the filtration substrate. The method associated with apparatus 10 is depicted in the flowchart of FIG. 2.

In the filter media, polarization of the molecules cause unlike charged particles to form ionic bonds with the filter molecules. In this way the particles will not detach from the filter molecules due to inelastic collisions with them. With increased polarization, stronger bonds are formed between ionized particles and the filter media.

The conditioning continues to promote inelastic collisions between charged particles and conglomerated particles outside the apparatus, due to ionization of particles that escape the media and that are conditioned by all three grids. A variety of airborne contaminants can be bound within the conglomeration. The conglomeration, in turn, improves the efficiency of further filtration. It is easier to capture a large particle than a small one.

The particles filtered by apparatus 10 can consist of any of a wide variety of known airborne contaminants. These contaminants can include, for example, smoke, dust, pollen, dander, bacteria, or viruses. The first voltage electrifies the first grid. This voltage is sufficiently high enough to set up an ion field to repel particles with the same charge. The only way these particles will get through the first grid is if other, oppositely charged particles coagulate with it and allow it to pass through the grid.

If a particle of an opposite charge approaches the first grid, it will be attracted to the grid and pass through it towards the second grid. By adding a third grid, ionization is further increased and will create optimized polarization of the filter media placed between the second and third grids, which in turn, further increases particle capture.

If the filter media is decreased in depth, and the grids surrounding the filter are brought closer to each other, the fields from the grids become stronger which results in increased polarization and, hence, a higher particle capture rate.

Enhancing Ionization

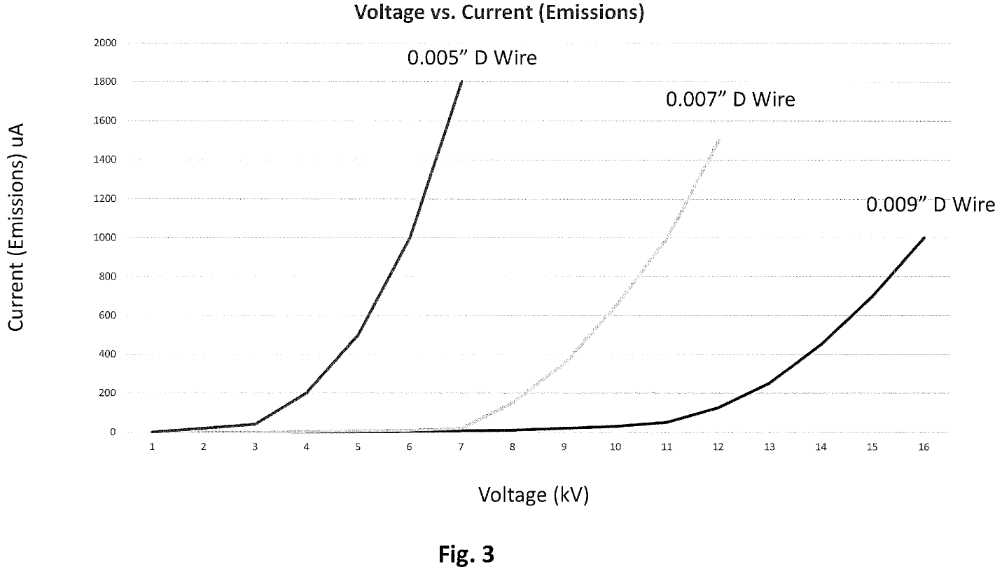

Particle ionization occurs when a particle passes through an ion field. Charge emissions are enhanced when a wire, or a plane field of wires with the proper geometry, or metal knife blades with the proper geometry, is utilized. Upon application of the voltage, electric fields concentrate on sharp points and/or on a thin edge. When the electric field is strong enough, charges are emitted to the surrounding space, thereby developing a space charge. The present disclosure illustrates grids employing wires, even though the same effect can be achieved via serrated edges or any sharp geometry. For example, if a negative high voltage is applied to a thin wire, electrons are emitted to the air surrounding the wire. The thinner the wire the more electrons emitted. As noted in the graph of FIG. 3, a 0.005″ diameter wire gives off a larger space charge then a 0.009″ diameter wire with the same voltage applied (this also applies to a positive field which produces positive ions).

If a particle passes through the negative ion field (electrons) surrounding the wire, the particle becomes negatively charged, thereby allowing its movement to be controlled by another grid (Grid 2) placed downstream with an opposite field applied to it. This allows for control of the conditioned particles. If another grid that has the same negative voltage applied to it, as the first grid, and is placed in downstream, the particle will be repelled by this grid because of the ion wall formed (like charges repel). Again, if a positively charged wire is placed downstream from the negatively charged wire the conditioned particle will be propelled towards this grid (unlike charges attract). This is how the trajectory of particles can be controlled using precisely controlled electromagnetic, electrostatic, and/or electrodynamic fields, or a combination of these.

Enhanced Polarization

After the ionized particles are conditioned by the above mechanisms, inelastic collisions are promoted. These inelastic collisions create larger particles. The conglomerated particles are large enough to greatly improve the efficiency of downstream filtration.

Any of a variety of known filter media can be used in connection with the apparatus of FIG. 1. The filter media can be used in conjunction with various filtration systems disclosed in the inventor's prior patents. These patents include U.S. Pat. Nos. 9,468,935; 9,028,588; 7,803,213; 7,404,847; and 7,175,695. The contents of these patents are fully incorporated herein for all purposes.

If a material contains molecules that can be polarized, they will generally be in random orientations when no electric field is applied. When the media material is influenced by a strong electrostatic field, such as a −20 kV field, dipoles are formed in the media. Every atom is composed of a positively charged nucleus and a negatively charged electron cloud, surrounding the nucleus. The electrons are at different energy levels, described by quantum mechanics, surrounding the nucleus. When the polarization electric field, Ep, is created the molecules polarize. Each molecule forms a dipole, (p=qd). Particles that are conditioned, as described above, are attracted to the polarized molecules in the filter.

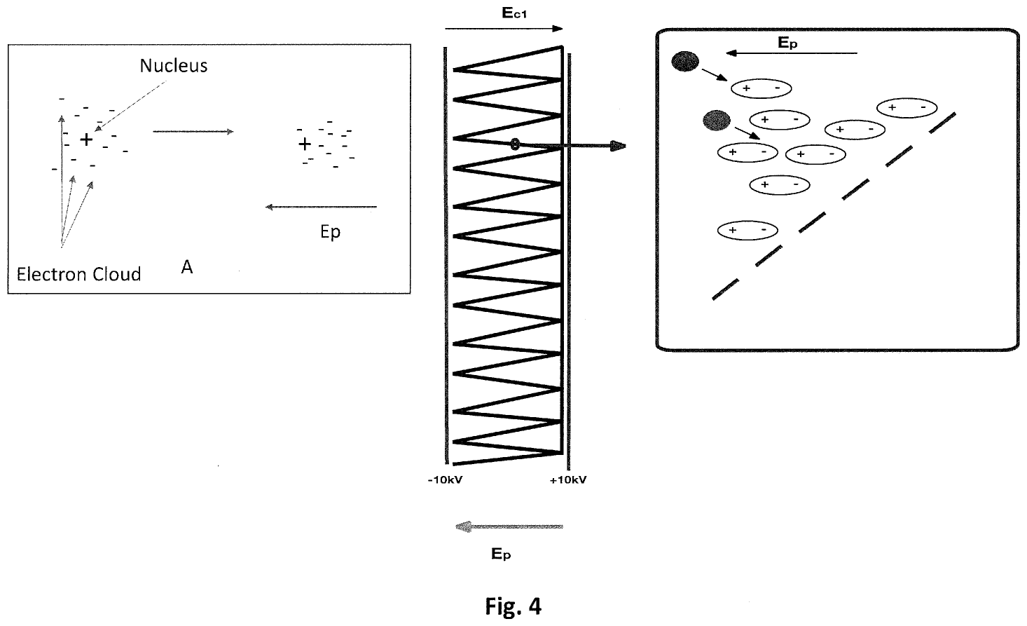

If two grids are placed on both sides of the filter media, a parallel plate capacitor is created. This is schematically illustrated in FIG. 4. When an electric field is applied to the grids, the electric field produced will polarize the filter media placed between the grids, as explained above. This field re-orients the dipole moments of the molecules. When a dielectric is placed between charged grids, the polarization of the media produces an electric field opposing the external field of the grids. The molecules in the dielectric filter media are “stretched” due to the electric field creating dipoles. The dielectric constant K reflects the amount of effective electric field present and indicates the capacitive strength of the field enhanced media. In other words, K indicates the amount of polarization of the filter molecules.

### Enhancing Polarization Utilizing a Polymeric Coating

Most polymers, made up of long chain-like molecules are very good insulators. For example, the most widely used polymer, polyethylene, can be formed into a material that conducts heat just as well as most metals, yet remains an electrical insulator

To change an insulator to a (semi) conductor, the polymer is doped with a doping agent, such as a strong acid, transitional metal, oxidants, etc. This way they can be prepared into electrical (semi)conducting functional materials.

For example, starting with trans-polyacetylene, it has been shown that its electrical conductivity can be increased by six orders of magnitude by exposing it to halogens vapors. The field of conducting polymers (CPs) has evolved to the point where these materials are being used in some commercial applications.

As used herein, CP refers to any 7-conjugated polymer; namely, a polymer having a backbone with alternating single and double (or triple) covalent bonds and that can transport charges, independently of their intrinsic conductivities (conductor or semiconductor) and charge transport characteristics.

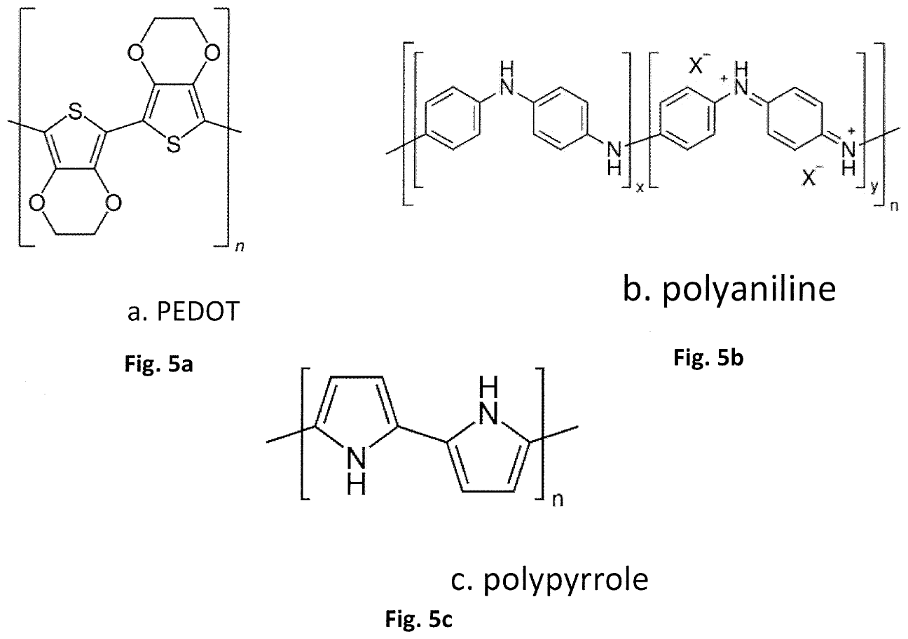

For example, the effect of doping trans-polyacetylene by exposing it to halogen vapors, reduces the energy gap and enhances the carrier density to achieve a different degree of conduction (even to the degree of making it act like a metal). Beyond trans-polyacetylene, which is composed of carbon and hydrogen, chemists recognized that the use of (hetero)aromatic rings (with sulfur and nitrogen in particular) transforms undoped polymers to intrinsic (semi) conducting properties. The chemical formulations of some CPs that are suitable for use in connection with the present invention include: poly(3,4-ethylenedioxythiophene) (PEDOT) (FIG. 5a); polyaniline (FIG. 5b); and polypyrrole (FIG. 5c). Again, as illustrated in FIG. 7a, any of these materials can be coated upon filter media 28.

Polypyrrole (PPy) is an organic polymer obtained by oxidative polymerization of pyrrole. It is a solid with the formula H(C₄H₂NH)ₙH. It is an intrinsically conducting polymer, used in electronics, optical, biological and medical fields.

Polyaniline (PANI-EB) Polyaniline (emeraldine base) (PANI-EB) is an intrinsically conducting polymer (ICP) that can be formed by oxidative polymerization of aniline, with an emeraldine base containing oxidized diamine and reduced diamine. PANI can be modified into the conjugating emeraldine base form by p-type doping with protonic acid. Poly(3,4-ethylenedioxythiophene) (PEDOT) is a conjugating polymer that has a conductivity of 300 S/cm. It can be copolymerized with poly(styrene-sulfonic acid) to form a water soluble polymeric film with high conductivity and transparency.

CPs can easily form coatings on filter materials at low processing temperatures. They have also shown exceptional stability at room temperature where commercial and residential air filters are generally used. Also, the conductivity of the coating can be controlled by the method of synthesis.

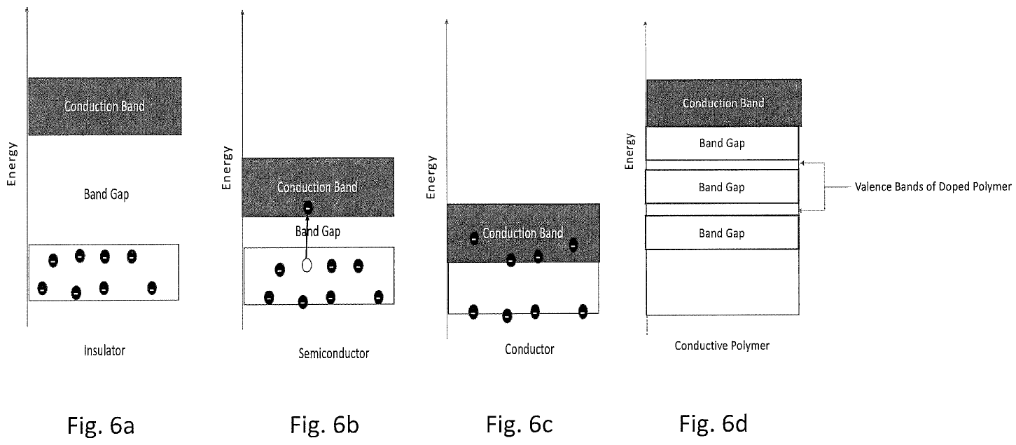

The poor conductivity of polymers is also explained by the band theory as illustrated in FIGS. 6a-6d. This theory says that the energy levels that electrons can occupy are grouped into allowed bands and may not have energy levels of electrons that are forbidden. The lowest bands are called valence bands and are inert from an electrical perspective. On the other hand, the highest bands, which participate in the electric conduction, are called conduction bands. Some conductors have a partially filled valence band that is relatively easier to excite to a higher energy level. Other conductors, such as divalent metals can have an overlap of the empty conductive band with a totally filled valence band. For semiconductor and insulators, the valence electrons must cross the band gap in order to result in conduction. A semiconductor has a smaller band gap energy than insulators have. The structure of these materials have conjugated chains, that is, an alternating single and double bond between the atoms. The process of doping conductive polymers becomes easier due to these conjugated bonds. In this process, defects and deformations in the polymeric chain are formed. An electron-deformation pair is responsible for the conductivity in polymers. The charges resulted in the doping process is the reason for their conductivity. The constant movement of the double bonds to stabilize the charge in the neighboring atoms causes the movement of charge, resulting in conductivity. This movement of double bonds is called resonance and it describes the delocalized electrons within a molecule. A delocalized electron is an electron, presented in a π bond, which is shared by three or more atoms. Due to this process there is a change in the band structure of the conductive polymer. It creates the conduction bands, allowed bands in the band gap, reducing the band gap energy, making the polymer able to conduct. The band gaps associated with various materials is illustrated in FIGS. 6a-6d.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An apparatus for improved filtration of airborne particles comprising:
a power source for delivering first, second, and third voltages to the apparatus;
a first grid consisting of a series of parallel wires, the first voltage being applied to the first grid to create a first electrical field, the first electrical field conditioning the airborne particles;
a second grid consisting of a series of parallel wires, the second voltage being applied to the second grid to create a second electrical field, the second electrical field attracting the conditioned airborne particles to the media, via the second grid from the first grid;
a third grid consisting of a series of parallel wires, the third voltage being applied to the third grid to create a third electrical field;
a filter media positioned between the second and third grids, the filter media including a conductive polymeric coating, the second and third electrical fields polarizing the coated filter media to thereby enhancing particle capture.

2. An apparatus for improved filtration comprising:
a pair of opposing grids, each grid creating an associated electrical field;
a filter positioned between the opposing grids, with the associated electrical fields polarizing the filter.

3. The apparatus as described in claim 2 wherein a conductive polymer material is coated upon the filter to thereby increase the polarization.

4. The apparatus as described in claim 3 wherein the conductive polymer is selected from the group consisting of: poly(3,4-ethylenedioxythiophene); polyaniline; and polypyrrole.

5. The apparatus as described in claim 2 further comprising a first grid positioned before the pair of opposing grids, with the first grid functioning to condition incoming particles.

6. The apparatus as described in claim 2 wherein the opposing grids are oppositely charged.

7. A method of filtering airborne contaminants comprising the following steps:
conditioning incoming contaminants with a first negatively charged grid, the conditioning applying a negative charge to the contaminates.
attracting the negatively charged contaminates to a second grid, the second grid being positively charged;
polarizing a filter media between two opposing electrical fields, the polarization of the filter media increasing its efficiency;
passing the contaminates through the polarized filter media.

8. The method as described in claim 7 comprising the further step of coating the filter media with a conductive polymer.
